(19) United States
(12) Patent Application Publication
(10) Pub. No.: US 2010/0306184 A1
(43) Pub. Date: Dec. 2, 2010

(54) METHOD AND DEVICE FOR PROCESSING WEBPAGE DATA

(76) Inventor: Tao Wang, Beijing (CN)

Correspondence Address: King & Spalding LLP, 401 Congress Avenue, Suite 3200, Austin, TX, 78701, US

(21) Appl. No.: 12/781,178

(22) Filed: May 17, 2010

(30) Foreign Application Priority Data
May 31, 2009 (CN) 200910143826.2

(51) Int. Cl. G06F 17/30; G06F 9/00

(52) U.S. Cl. 707/707; 726/11; 707/E17.108

(57) ABSTRACT

A method and device for processing webpage data has the following steps: checking whether or not the webpage data included in the response message to be sent by a website to a search engine includes a particular character; and shielding the particular character included in the webpage data when the result of the checking is affirmative. By using the method and device, it is possible to prevent hackers from carrying out unauthorized operations on websites by way of Google hacking.

### CROSS-REFERENCE TO RELATED APPLICATIONS

This application claims priority to Chinese Patent Application No. 200910143826.2 filed May 31, 2009, the contents of which is incorporated herein by reference in its entirety.

### TECHNICAL FIELD

The present invention relates to a method and device for processing webpage data.

### BACKGROUND

Nowadays, when people surf the Internet they usually use search engines, such as Google, Yahoo, Baidu, etc. to retrieve information of interest from the massive information on the Net.

The search engines usually include website crawlers, search databases and retrieval tools, wherein the website crawlers are used to acquire the webpage data of the various websites periodically from various websites, the search databases are used to store the webpage data of the various website acquired by the website crawlers, and the retrieval tools are used to retrieve the webpage data including the information of interest from the search databases according to people's requests. With search engines, when people want to retrieve information of interest from the Internet they can input keywords associated with the information of interest into the retrieval tools of the search engines, the retrieval tools of the search engines then retrieve the webpage data including the information associated with the inputted keywords from the search databases of the search engines and display them to people.

Since the webpage data stored in the search databases of the search engines are from various websites and some of the webpage data are likely to include characters disclosing website information (for example, the types and versions of the operating systems used in the websites, the types and versions of the databases used in the websites, the information on the application programs running on the websites, etc.), hackers can use the search engines to retrieve the webpage data including the characters disclosing website information and find the websites having security defects or hidden problems by analyzing these characters disclosing website information included in the retrieved webpage data, so as to carry out unauthorized operations on these websites by using the security defects or hidden problems in these websites, for example, stealing user information from the websites, installing malicious codes into the websites, etc.

This is a hacking technique for carrying out unauthorized operations on websites by using the search engines, which has appeared in recent years, and this hacking technique is also referred to as Google hacking. For example, in 2004 hackers developed a worm Santy by using the security defects existing in the forum application program phpBB to maliciously attack the websites that run the forum application program phpBB, causing about 15,000 websites to be infected with the worm Santy. First, the worm Santy retrieved the webpage data including the characters “phpBB” with the Google search engine and found the network addresses of the websites running the forum application program phpBB based on the retrieved webpage data, then the worm Santy invaded these websites according to the network address found and installed itself into these websites by using the security defects in the forum application program phpBB running on these websites. For another example, in 2008 SQL Injection Attack occurred and caused about 14,000 websites to be infected with the virus. First, the SQL Injection Attack retrieved the webpage data that included the characters “ASP” and “id=” with the Google search engine, identified the websites which were running ASP scripts and had “id=” in their uniform resource locators (URL) based on the retrieved webpage data, then the SQL Injection Attack found the websites having SQL Injection Attack weaknesses from these identified websites, and finally the SQL Injection Attack injected malicious codes into these websites having SQL Injection Attack weaknesses, which malicious code attempted to install the virus called “Trojan” into the user computers accessing the websites.

In order to prevent hackers from carrying out unauthorized operations on websites by using Google hacking, a variety of solutions have been proposed.

One approach is that in the root directory of the website a file “robots.txt” is created to provide the rules which webpage crawlers should follow, a website administrator can use the file robots.txt to specify the webpage data file including the website information and/or the file directory containing such files that are not permitted for acquisition by webpage crawlers. However, the file robots.txt supports only prevention of the extraction of the entire file or file directory, that is, if in robots.txt it is specified that a webpage data file or a file directory containing the webpage data file is not permitted for extraction by webpage crawlers, the specified webpage data file or all webpage data files included in the specified file directory containing the webpage data files will not be extracted by the webpage crawlers. In this case, if in robots.txt it is specified that the webpage data file of the website homepage is not permitted for extraction by webpage crawlers, it is impossible for people to find the website homepage by search engines, which is not acceptable to website administrators.

Another approach is that people have attempted to use a web application firewall (WAF: Web Application Firewall) deployed widely to reduce attacks to websites. However, the web application firewall is only used for filtering the requests sent by visitors to a website, so as to check whether or not malicious attack codes are included in the requests, therefore, the existing web application firewalls cannot prevent hackers from carrying out unauthorized operations on websites by using Google hacking.

There are also some approaches, in which by way of modifying the source codes of a website, hackers are prevented from carrying out unauthorized operations on websites by using Google hacking. However, such approaches are not suitable in all cases, for example, if there is no source code in the application program running on the website, it is infeasible to use this way of modifying source code to prevent hackers from carrying out unauthorized operations on the website by way of Google hacking.

### SUMMARY

According to various embodiments, a method and device for processing webpage data can be provided, which shields any character that may disclose website information included in the webpage data sent from a website to a search engine, thereby preventing hackers from carrying out unauthorized operations on a website by way of Google hacking.

According to an embodiment, a method for processing webpage data, may comprise: checking whether or not the webpage data included in the response message to be sent by a website to a search engine includes a particular character, and shielding the particular character included in the webpage data when the result of the checking is affirmative.

According to a further embodiment of the above method, the shielding step may further comprise replacing the particular character included in the webpage data with another character different from the particular character, when the result of checking is affirmative and the particular character is not included in the uniform resource locator included in the webpage data. According to a further embodiment of the above method, the shielding step may further comprise: replacing the relative address in the uniform resource locator with a scrambled relative address obtained by carrying out scrambling processing on the relative address in the uniform resource locators, when the result of checking is affirmative and the particular character is included in the uniform resource locator included in the webpage data. According to a further embodiment of the above method, the method may further comprise the step of replacing the relative address of the webpage data included in a request message with a descrambled relative address obtained by carrying out descrambling processing on the scrambled relative address, when the request message for requesting webpage data to be sent to the website is received and the relative address of the webpage data included in the request message is the scrambled relative address. According to a further embodiment of the above method, the method may further comprise the steps of determining whether or not the response message is sent by the website to the search engine; and checking whether or not the webpage data includes the particular character, when the result of the determining is affirmative. According to a further embodiment of the above method, the determining step may further comprise detecting whether or not the address and port number of the initiator of the communication connection via which the response message passes are identical to the address and port number of the initiator of the communication connection via which the request message to be sent to the website previously by the search engine passes; and making a judgement that the response message is sent by the website to the search engine, when the result of the detecting is affirmative. According to a further embodiment of the above method, the particular character may include the character that may disclose the information of the website. According to a further embodiment of the above method, the other character may include a space character.

According to yet another embodiment, a device for processing webpage data may comprise a checking module for checking whether or not the webpage data included in a response message to be sent by a website to a search engine includes a particular character; and a shielding module for shielding the particular character included in the webpage data when the result of checking is affirmative. According to a further embodiment of the above device, the shielding module may further be used to replace the particular character included in the webpage data with another character different from the particular character, when the result of checking is affirmative and the particular character is not included in a uniform resource locator included in the webpage data. According to a further embodiment of the above device, the shielding module may further be used to replace the relative address in the uniform resource locator with a scrambled relative address obtained by carrying out scrambling processing on the relative address in the uniform resource locator, when the result of checking is affirmative and the particular character is included in the uniform resource locator included in the webpage data. According to a further embodiment of the above device, it may further comprise a replacing module for replacing the relative address of the webpage data included in a request message with a descrambled relative address obtained by carrying out descrambling processing to the scrambled relative address, when the request message for requesting webpage data to be sent to the website is received and the relative address of the webpage data included in the request message is the scrambled relative address. According to a further embodiment of the above device, it may further comprise a determining module for determining whether or not the response message is sent by the website to the search engine, wherein the checking module is further used to check whether or not the webpage data includes the particular character when the result of determining is affirmative. According to a further embodiment of the above device, the determining module may further comprise a detecting module for detecting whether or not the address and port number of the initiator of the communication connection via which the response message passes are identical to the address and port number of the initiator of the communication connection via which the request message to be sent to the website previously by the search engine passes; and a judging module for judging the response message is sent by the website to the search engine, when the result of the detecting is affirmative.

According to yet another embodiment, a webpage application firewall may comprise an intercepting module for intercepting a response message to be sent by a website to a search engine; a checking module for checking whether or not the webpage data included in the intercepted response message includes a particular character; a shielding module for shielding the particular character included in the webpage data included in the intercepted response message, when the result of the checking is affirmative; and a sending module for sending to the search engine the intercepted response message with the particular character having been shielded.

According to a further embodiment of the above webpage application firewall, the shielding module may further be used to replace the particular character included in the webpage data with another character different from the particular character, when the result of the checking is affirmative and the particular character is not included in a uniform resource locator included in the webpage data. According to a further embodiment of the above webpage application firewall, the shielding module may further be used to replace the relative address in the uniform resource locator with a scrambled relative address obtained by carrying out scrambling processing on the relative address in the uniform resource locator, when the result of the checking is affirmative and the particular character is included in the uniform resource locator included in the webpage data.

According to yet another embodiment, a machine readable medium may store an instruction set, which enables a machine to execute the method as described above, when the instruction set is executed.

### BRIEF DESCRIPTION OF THE DRAWINGS

Other characteristics, features and advantages of the present invention will become more apparent through the detailed description hereinafter combined with the accompanying drawings, in which:

FIG. 1 shows a schematic diagram of an implementation scenario according to an embodiment;

FIG. 2 is an exemplary schematic diagram showing the HTTP request message according to an embodiment;

FIGS. 3A and 3B is a flowchart showing the method for processing webpage data to be performed by a web application firewall according to an embodiment;

FIG. 4A shows a schematic diagram of the HTTP request message having a scrambled relative address of the webpage data and scrambled identifiers according to an embodiment;

FIG. 4B shows a schematic diagram of the HTTP request message having an unscrambled relative address of the webpage data according to an embodiment;

FIG. 5A shows a schematic diagram of the uniform resource locators, which have an unscrambled relative address and are included in the webpage data according to an embodiment; and

FIG. 5B shows a schematic diagram of the uniform resource locators, which have a scrambled relative address and scrambled identifiers and are included in the webpage data according to an embodiment.

### DETAILED DESCRIPTION

A method for processing webpage data according to various embodiments comprises: checking whether or not the webpage data included in the response message to be sent by the website to a search engine includes a particular character, and shielding said particular character included in said webpage data when the result of checking is affirmative.

A device for processing webpage data according to various embodiments comprises: a checking module for checking whether or not the webpage data included in the response message to be sent by the website to a search engine includes a particular character, and a shielding module for shielding said particular character included in said webpage data when the result of checking is affirmative.

A web application firewall according to various embodiments comprises: an intercepting module for intercepting a response message to be sent by a website to a search engine; a checking module for checking whether or not the webpage data included in said intercepted response message includes a particular character; a shielding module for shielding said particular character included in said webpage data included in said intercepted response message when the result of checking is affirmative; and a sending module for sending to said search engine said intercepted response message with said particular character having been shielded.

Various embodiments will be described in detail hereinafter in conjunction with the accompanying drawings.

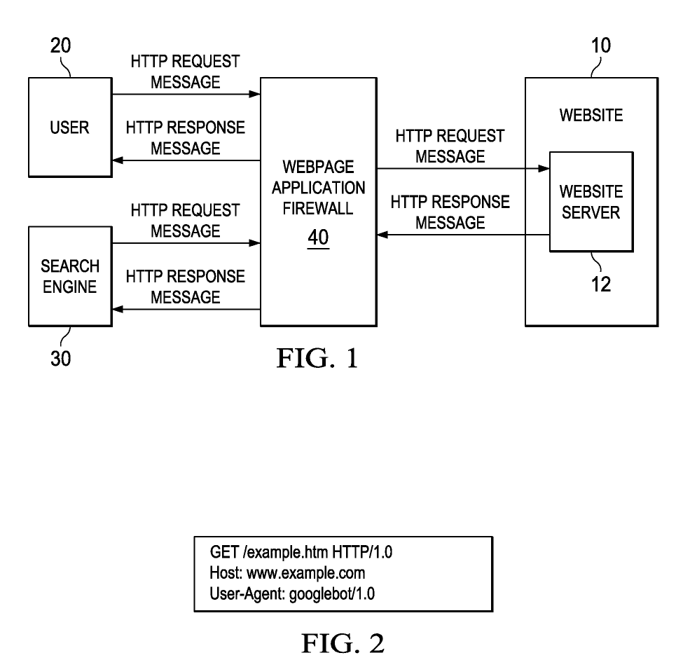

FIG. 1 shows a schematic diagram of an implementation scenario according to an embodiment. The implementation scenario shown in FIG. 1 comprises a website 10, a user 20, a search engine 30 and a web application firewall (WAF) 40.

In this case, the website 10 comprises a website server 12 which stores various webpage data in the website 10.

The user 20 can be a person and/or a program other than the search engine 30. The user 20 can visit the website 10 to request the webpage data from the website 10 or retrieve the webpage data including the information of interest through the search engine 30. When the user 20 visits the website 10, the user 20 as an initiator first establishes a communication connection to the website server 12 of the website 10, then the user 20 sends an HTTP request message to the website server 12 via the established communication connection, so as to request the webpage data of the website 10, and the website server 12 returns an HTTP response message including the requested webpage data to the user 20 via the established communication connection in response to the HTTP request message. In this case, the established communication connection comprises the address and the port number of the user 20 as the initiator and that of the website server 12 as a destination party.

The search engine 30 comprises a website crawler, a search database and a search tool (not shown). The website crawler of the search engine 30 visits the website 10 periodically to request the webpage data of the website 10 and stores the requested webpage data into the search database of the search engine 30. When the website crawler of the search engine 30 visits the website 10, the website crawler of the search engine 30 as an initiator first establishes a communication connection to the website server 12 of the website 10, then the website crawler of the search engine 30 sends a HTTP request message to the website server 12 via the established communication connection, so as to request the webpage data of the website 10, and the website server 12 returns an HTTP response message including the requested webpage data to the website crawler of the search engine 30 via the established communication connection in response to the HTTP request message, in which the established communication connection comprises the address and the port number of the website crawler of the search engine 30 as the initiator and of the website server 12 as the destination party. Normally, the website crawler of the search engine 30 first sends the HTTP request message for requesting the webpage data of the homepage of the website 10 to the website server 12 of the website 10, then after the website server 12 has received the webpage data of the homepage of the website 10, according to the uniform resource locators (URL) that direct other webpage data of the website 10 and are included in the webpage data of the homepage of the website 10, the website crawler of the search engine 30 continues to send the HTTP request message to the website server 12 to request other webpage data of the website 10. In this manner, the search engine 30 can acquire various webpage data available on the website 10.

The webpage application firewall (WAF) 40 is used to monitor the communication connection between the user 20 and/or the search engine 30 and the website server 12 of the website 10 and to intercept the HTTP request message for requesting the webpage data of the website 10 sent by the user and/or the search engine 30 to the website 10 via the communication connection and the HTTP response message including the webpage data sent by the website 10 to the user 20 and/or the search engine 30 in response to the HTTP request from the user 20 and the search engine 30.

The web application firewall (WAF) 40 is pre-stored with particular characters which may disclose the website information. When the webpage application firewall 40 intercepts an HTTP response message sent by the website 10, which is being sent to the search engine 30, the webpage application firewall 40 checks whether or not the webpage data included in the HTTP response message being sent to the search engine 30 includes these particular characters that may disclose website information, and uses, when the result of checking is affirmative, other characters to shield these particular characters disclose the website information that may included in the webpage data included in the HTTP response message sent to the search engine 30, thereby achieving the purpose of preventing hackers from carrying out unauthorized operations to the website by way of Google hacking.

FIG. 2 is an exemplary schematic diagram showing the HTTP request message according to an embodiment. As shown in FIG. 2, the HTTP request message includes a domain “User-Agent” representing the identification of a webpage data requester and a domain “Host” representing the base address of the requested webpage data. In an example of the HTTP request message shown in FIG. 2, the identification of the webpage data requester is “googlebot/1.0”, i.e., the identification of the website crawler of a Google search engine, and the base address of the requested webpage data is “www.example.com”. In addition to this, the HTTP request message also includes the relative address of the requested webpage data, in this example, the relative address of the requested webpage data is “/example.htm”. The base address and relative address of the requested webpage data constitute the uniform resource locator of the requested webpage data. It can be seen from the above that, the HTTP request message comprises the identification of webpage data requesters, therefore based on the HTTP request message, it can be determined that the requester requesting the webpage data is a search engine or a user other than the search engine.

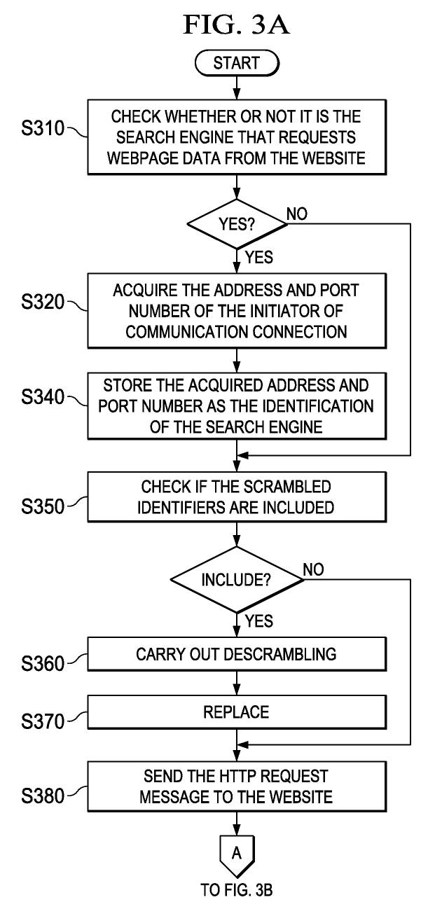

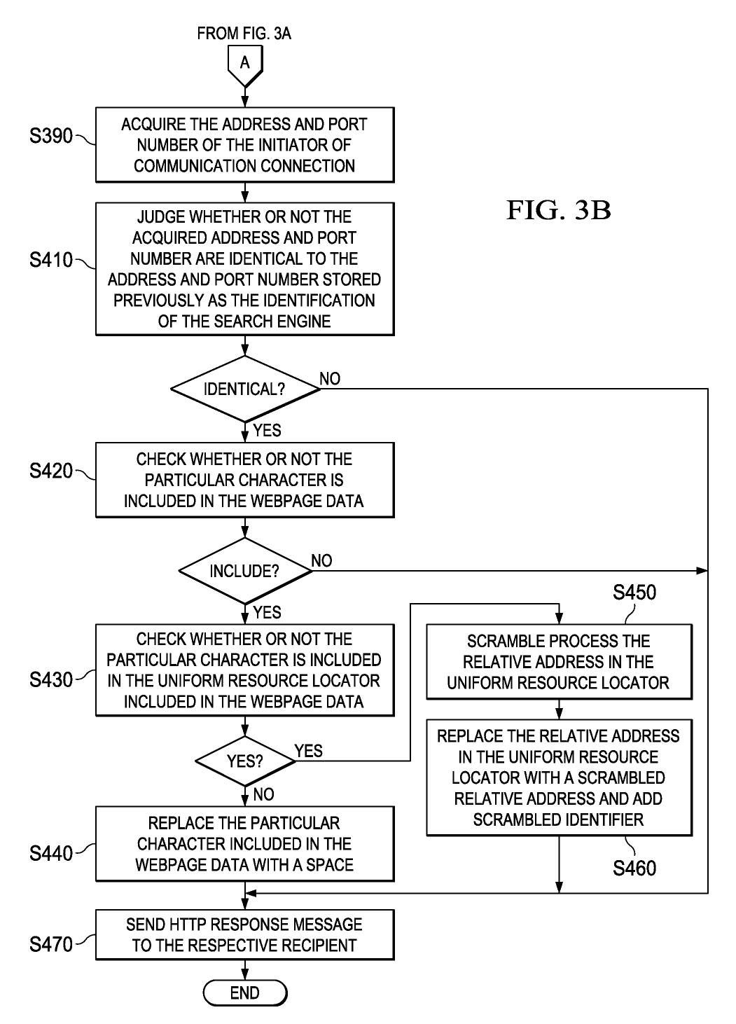

FIGS. 3A and 3B are flowcharts showing the method for processing webpage data executed by a web application firewall according to an embodiment.

As shown in FIG. 3, when the webpage application firewall 40 intercepts an HTTP request message H for requesting webpage data to be sent by the user 20 and/or the search engine 30 to the website server 12 of the website 10, the webpage application firewall 40 checks whether or not it is the search engine 30 requesting webpage data from the website 10 according to the identification of webpage data requester included in the intercepted HTTP request message H (step S310).

When the result of the checking in step S310 is negative, the flow goes to step S350.

When the result of the checking in step S310 is affirmative, the webpage application firewall 40 acquires the address and port number of the initiator of the communication connection via which the intercepted HTTP request message H has passed (step S320).

The webpage application firewall 40 stores the acquired address and port number as the identification of the search engine 30 (step S340).

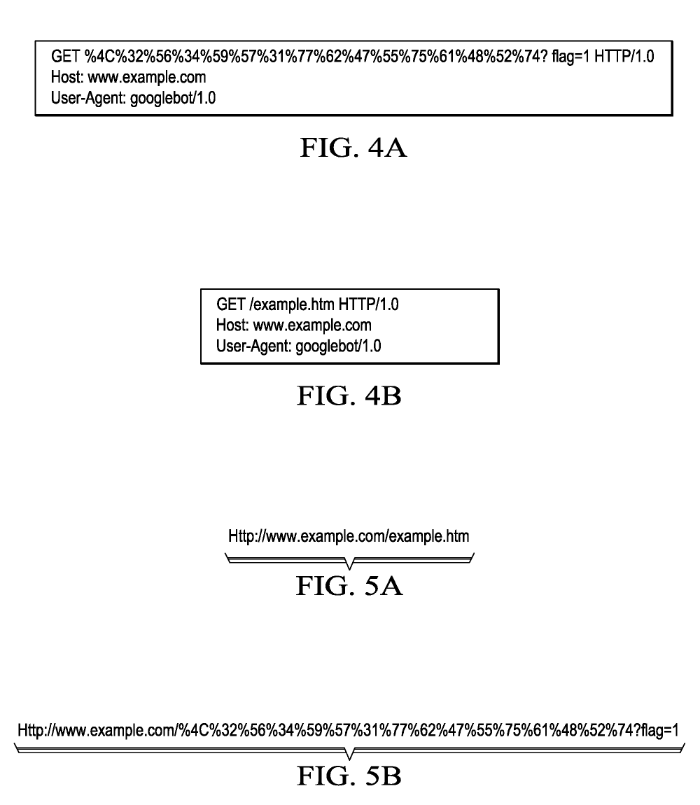

The webpage application firewall 40 checks whether or not the relative address of the webpage data included in the intercepted HTTP request message H includes the scrambled identifier representing that the relative address of the webpage data included in the intercepted HTTP request message H has been scramble-processed (step S350). FIG. 4A shows a schematic diagram of the HTTP request message having a scrambled relative address of the webpage data and a scrambled identifier according to an embodiment, wherein “%4C%32%56%34%59%57%31%77%62%47%55%75%61%48%52%74?” is the scrambled relative address of the webpage data, and “flag=1” is the scrambled identifier.

When the result of the checking in step S350 is negative, the flow goes to step S380.

When the result of the checking in step S350 is affirmative, the webpage application firewall 40 uses a pre-assigned descrambling method to descramble the relative address of the webpage data included in the intercepted HTTP request message H, so as to obtain the descrambled relative address (step S360). In the embodiment, the descrambling method can carry out the descrambling by using BASE64 and URLENCODE algorithms in succession.

The webpage application firewall 40 replaces the relative address of the webpage data included in the intercepted HTTP request message H with the descrambled relative address (step S370). FIG. 4B shows a schematic diagram of the HTTP request message having an unscrambled relative address of the webpage data according to an embodiment, in which “example.htm” is the unscrambled relative address of the webpage data.

The webpage application firewall 40 sends the intercepted HTTP request message H to the website server 12 of the website 10 (step S380).

When the webpage application firewall 40 intercepts the HTTP response message T to be sent by the website server 12 of the website 10 to the user 20 or the search engine 30, the webpage application firewall 40 acquires the address and port number of the initiator of the communication connection via which the intercepted HTTP response message T has passed (step S390).

The webpage application firewall 40 judges whether or not the acquired address and port number are identical to the address and port number stored previously as the identification of the search engine 30 (step S410).

When the result of the judging in step S410 is negative, it indicates that the intercepted HTTP response message T is not to be sent to the search engine 30, and the flow goes to step S470.

When the result of the judging in step S410 is affirmative, it indicates that the intercepted HTTP response message T is to be sent to the search engine 30, the webpage application firewall 40 checks whether or not the webpage data included in the intercepted HTTP response message T includes a pre-stored particular character which may disclose website information (step S420).

When the result of the checking in step S420 is negative, the flow goes to step S470.

When the result of the checking in step S420 is affirmative, the webpage application firewall 40 further checks whether or not the particular character is included in the uniform resource locators included in the webpage data included in the intercepted HTTP response message T (step S430).

When the result of the further checking in step S430 is negative, it indicates that the particular character is not included in the uniform resource locators included in the webpage data included in the intercepted HTTP response message T, so that the webpage application firewall 40 replaces the particular character included in the webpage data included in the intercepted HTTP response message T with a space character (step S440), to shield the particular character included in the webpage data, and then the flow goes to step S470.

When the result of the further checking in step S430 is affirmative, it indicates that the particular character is included in the uniform resource locators included in the webpage data included in the intercepted HTTP response message T, the webpage application firewall 40 uses a scrambling method corresponding to the descrambling method mentioned in step S360 to carry out scrambling processing on the relative address in the uniform resource locators included in the webpage data included in the intercepted HTTP response message T, so as to obtain the scrambled relative address (step S450). In this embodiment, the scrambling method can carry out the scrambling processing by using BASE64 and URLENCODE algorithms in succession. FIG. 5A shows a schematic diagram of the uniform resource locators having unscrambled relative address and included in the webpage data according to an embodiment, in which “example.htm” is the unscrambled relative address.

The webpage application firewall 40 replaces the relative address in the uniform resource locators included in the webpage data included in the intercepted HTTP response message T with the scrambled relative address so as to shield the particular character included in the webpage data, and adds a scrambling identifier, which represents that the relative address of the uniform resource locators has been scrambled, into the uniform resource locators (step S460). FIG. 5B shows a schematic diagram of the uniform resource locators, which has a scrambled relative address and a scrambled identifier and is included in the webpage data according to an embodiment, wherein “%4C%32%56%34%59%57%31%77%62%47%55%75%61%48%52%74?” is the scrambled relative address, and “flag=1” is the scrambling identifier.

The webpage application firewall 40 sends the intercepted HTTP response message T to a corresponding recipient (step S470).

### Other Variations

It should be understood by those skilled in the art that, although in the above embodiments that a particular character may disclose website information included in the uniform resource locators included in the webpage data included in HTTP response message is also shielded, the present invention is not limited thereto. In other embodiments, it is also feasible that only the particular character included in those parts, which is not the uniform resource locators, in the webpage data included in the HTTP response message is shielded. In this way, the possibility for hackers to conduct unauthorized operations on a website by way of Google hacking can be reduced significantly.

It should be understood by those skilled in the art that, while in the above embodiments, the descrambling and scrambling methods adopt BASE64 and URLENCODE algorithms, the present invention is not limited thereto. In other embodiments, the descrambling and scrambling methods can adopt various other available algorithms.

It should be understood by those skilled in the art that, although in the above embodiments, when the webpage data included in the intercepted HTTP response message includes a particular character that may disclose website information but the particular character is not included in the uniform resource locators included in the webpage data, a space character is used to replace the particular character included in the webpage data, the present invention is not limited thereto. In other embodiments, characters other than a space can also be used to replace the particular character included in the webpage data, for example, the other characters can be symbols such as ?, !, #, etc.

It should be understood by those skilled in the art that, although the above embodiments are realized on the basis of the HTTP protocol and the request message for requesting webpage data sent by the user 20 and the search engine 30 to the website 10 is a HTTP request message following the HTTP protocol, as well as that the response message including the webpage data returned by the website 10 to the user 20 and the search engine 30 is a HTTP response message following the HTTP protocol, the present invention is not limited thereto. Other embodiments can also be implemented on the basis of protocols other than the HTTP protocol.

It should be understood by those skilled in the art that, although in the above embodiments, the method for processing webpage data is implemented in the webpage application firewall 40, the present invention is not limited thereto. In other embodiments, the method for processing webpage data can also be implemented in the search engine 30 or in the website server 12. In this case, the method for processing webpage data implemented in the website server 12 is identical to the method implemented in the webpage application firewall 40 as described in the above embodiments. The difference between the method for processing webpage data implemented in the search engine 30 and the method implemented in the webpage application firewall 40 as described in the above embodiments is that, the search engine 30 does not need the step for judging whether or not the response message received by it is sent by the website 10 to the search engine 30, because it is affirmative that the response message received by the search engine 30 is sent by the website 10 to the search engine 30.

Each of the steps of the method disclosed in each of the above embodiments can be implemented by way of software, hardware, or a combination thereof.

It should be understood by those skilled in the art that, various variations and modifications of each of the embodiments can be made without departing from the spirit of the present invention, and these variations and modifications are all within the protective scope of the present invention. Therefore, the protective scope of the present invention is defined by the appended claims.

What is claimed is:

1. A method for processing webpage data, comprising:
checking whether or not the webpage data included in the response message to be sent by a website to a search engine includes a particular character, and
shielding said particular character included in said webpage data when the result of the checking is affirmative.

2. The method according to claim 1, wherein said shielding step further comprises:
replacing said particular character included in said webpage data with another character different from said particular character, when said result of checking is affirmative and said particular character is not included in the uniform resource locator included in said webpage data.

3. The method according to claim 1, wherein said shielding step further comprises:
replacing the relative address in said uniform resource locator with a scrambled relative address obtained by carrying out scrambling processing on the relative address in said uniform resource locators, when said result of checking is affirmative and said particular character is included in the uniform resource locator included in said webpage data.

4. The method according to claim 3, wherein the method further comprises the step of:
replacing the relative address of the webpage data included in a request message with a descrambled relative address obtained by carrying out descrambling processing on said scrambled relative address, when said request message for requesting webpage data to be sent to said website is received and the relative address of the webpage data included in said request message is said scrambled relative address.

5. The method according to claim 1, wherein the method further comprises the steps of:
determining whether or not said response message is sent by said website to said search engine; and
checking whether or not said webpage data includes said particular character, when the result of the determining is affirmative.

6. The method according to claim 5, wherein said determining step further comprises:
detecting whether or not the address and port number of the initiator of the communication connection via which said response message passes are identical to the address and port number of the initiator of the communication connection via which the request message to be sent to said website previously by said search engine passes; and
making a judgement that said response message is sent by said website to said search engine, when the result of the detecting is affirmative.

7. The method according to claim 1, wherein said particular character includes the character that may disclose the information of said website.

8. The method according to claim 2, wherein said other character includes a space character.

9. A device for processing webpage data, comprising:
a checking module for checking whether or not the webpage data included in a response message to be sent by a website to a search engine includes a particular character; and
a shielding module for shielding said particular character included in said webpage data when the result of checking is affirmative.

10. The device according to claim 9, wherein,
said shielding module is further used to replace said particular character included in said webpage data with another character different from said particular character, when said result of checking is affirmative and said particular character is not included in a uniform resource locator included in said webpage data.

11. The device according to claim 9, wherein,
said shielding module is further used to replace the relative address in the uniform resource locator with a scrambled relative address obtained by carrying out scrambling processing on the relative address in the uniform resource locator, when said result of checking is affirmative and said particular character is included in the uniform resource locator included in said webpage data.

12. The device according to claim 11, further comprises:
a replacing module for replacing the relative address of the webpage data included in a request message with a descrambled relative address obtained by carrying out descrambling processing to said scrambled relative address, when said request message for requesting webpage data to be sent to said website is received and the relative address of the webpage data included in said request message is said scrambled relative address.

13. The device according to claim 9, further comprising a determining module for determining whether or not said response message is sent by said website to said search engine,
wherein said checking module is further used to check whether or not said webpage data includes said particular character when the result of determining is affirmative.

14. The device according to claim 13, wherein said determining module further comprises:
a detecting module for detecting whether or not the address and port number of the initiator of the communication connection via which said response message passes are identical to the address and port number of the initiator of the communication connection via which the request message to be sent to said website previously by said search engine passes; and
a judging module for judging said response message is sent by said website to said search engine, when the result of the detecting is affirmative.

15. A webpage application firewall, comprising:
an intercepting module for intercepting a response message to be sent by a website to a search engine;
a checking module for checking whether or not the webpage data included in said intercepted response message includes a particular character;
a shielding module for shielding said particular character included in said webpage data included in said intercepted response message, when the result of the checking is affirmative; and
a sending module for sending to said search engine said intercepted response message with said particular character having been shielded.

16. The webpage application firewall according to claim 15, wherein,
said shielding module is further used to replace said particular character included in said webpage data with another character different from said particular character, when said result of the checking is affirmative and said particular character is not included in a uniform resource locator included in said webpage data.

17. The webpage application firewall according to claim 15, wherein,
said shielding module is further used to replace the relative address in said uniform resource locator with a scrambled relative address obtained by carrying out scrambling processing on the relative address in said uniform resource locator, when said result of the checking is affirmative and said particular character is included in the uniform resource locator included in said webpage data.

18. A machine readable medium comprising a set of instructions, which when executed on a machine perform:
checking whether or not the webpage data included in the response message to be sent by a website to a search engine includes a particular character, and
shielding said particular character included in said webpage data when the result of the checking is affirmative.

19. The machine readable medium according to claim 18, wherein said shielding further comprises:
replacing said particular character included in said webpage data with another character different from said particular character, when said result of checking is affirmative and said particular character is not included in the uniform resource locator included in said webpage data.
